(19) United States
(12) Patent Application Publication
(10) Pub. No.: US 2014/0081675 A1
(43) Pub. Date: Mar. 20, 2014

(54) SYSTEMS, METHODS, AND APPARATUS FOR OPTIMIZING CLAIM APPRAISALS

(71) Applicant: The Travelers Indemnity Company, Hartford, CT (US)

(72) Inventors: Richard C. Ives, Stafford Springs, CT (US); Erin N. McIntosh, Higganum, CT (US); Allison G. Thomson-Vicuna, East Granby, CT (US); Jared C. Krechko, Manchester, CT (US); Thomas G. Phillips, New Hartford, CT (US); Kimberly H. Yerino, New Haven, CT (US); Jennifer C. Lostowski, East Granby, CT (US)

(73) Assignee: The Travelers Indemnity Company, Hartford, CT (US)

(21) Appl. No.: 14/030,339

(22) Filed: Sep. 18, 2013

Related U.S. Application Data
(60) Provisional application No. 61/703,199, filed on Sep. 19, 2012.

(51) Int. Cl. G06Q 40/08

(52) U.S. Cl. CPC G06Q 40/08
USPC 705/4

(57) ABSTRACT

Systems, apparatus, methods, and articles of manufacture provide for assessing a likelihood of total loss of insured property (e.g., an insured automobile) and/or assessing an expected severity of damage to insured property. In some embodiments, information, such as information relating to insured property (e.g., age of a vehicle) and/or claim information (e.g., information relating to circumstances of an auto accident), may be used in determining a total loss score and/or damage severity score, without requiring a professional estimate or appraisal of damage to insured property.

### CROSS-REFERENCE TO RELATED APPLICATIONS

The present application claims the benefit of priority of U.S. Provisional Patent Application No. 61/703,199 filed Sep. 19, 2012, entitled “SYSTEMS, METHODS, AND APPARATUS FOR OPTIMIZING CLAIM APPRAISALS.” The application identified above is incorporated by reference in the present application.

### BACKGROUND

Insurance providers assessing a notice of loss or claim of damage to insured property typically conduct an in-person appraisal of physical damage, such as a field appraisal by an appraisal professional. Accordingly, the costs incurred in managing damage claims may include the salary, benefits, transportation costs, and other costs associated with such appraisal professionals. Field appraisals are often required regardless of the actual severity of any physical damage, leading to the inefficient allocation of professional personnel and services for situations that may not require in-person inspections, such as for very light damage, or very extensive or total damage (e.g., a total loss). Despite the importance to the insurance industry of reducing costs and assigning professionals and resources efficiently to manage claims of physical damage, previous systems and practices have failed to optimize claim damage appraisals.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1A is a diagram of a system according to some embodiments of the present invention;

FIG. 1B is a diagram of a claim management system according to some embodiments of the present invention;

FIG. 2 is a diagram of a computer system according to some embodiments of the present invention;

FIG. 3 is a flowchart of a method according to some embodiments of the present invention;

FIG. 4 is a flowchart of a method according to some embodiments of the present invention;

FIG. 5 is a flowchart of a method according to some embodiments of the present invention;

FIG. 6 depicts an example user interface according to some embodiments of the present invention;

FIG. 7 depicts an example user interface according to some embodiments of the present invention; and

FIG. 8 depicts an example user interface according to some embodiments of the present invention.

### DETAILED DESCRIPTION

Applicants have recognized that, in accordance with some embodiments described in this disclosure, insurance providers, insurance claim professionals, and others may find it beneficial: (i) to establish coefficients and other factors useful for managing damage claim appraisals (e.g., for use in determining a preferred option to appraise a damage claim); (ii) to determine a score or other value for use in determining (e.g., based on one or more coefficients and/or information about a claim) a preferred option for appraising a damage claim (e.g., requiring a professional of an insurance provider to perform an appraisal in person, requesting that a claimant provide a repair estimate or other appraisal, or defining damage as a total loss); (iii) to determine a preferred option for appraising a damage claim (e.g., based on one or more coefficients, a score, and/or information about a claim); and/or (iv) to provide for more efficient claim management by recommending or otherwise indicating one or more actions (e.g., to a claimant, to an insurance provider, and/or to a claim professional) for appraising a damage claim.

Some embodiments described in this disclosure provide for the aggregation, analysis, and preparation of data (e.g., historical claim data, property data, damage claim data, and/or vehicle data) for use in providing one or more of the beneficial functions described in this disclosure.

Applicants have recognized that it may be desirable, in accordance with some embodiments, to provide a user interface for determining at least one score or other metrics, associated with a damage claim, which may be used in determining a recommended action for assessing claim severity (e.g., damages). In one embodiment, a user interface (e.g., provided via an application, such as a web browser, running on or presented via a computing device) allows for receiving information (e.g., from a claim professional, claimant, or other user, and/or from a server computer) for determining a score. Alternatively or in addition, the determined score may be received from another computing device (e.g., a remote server, a web server) and/or may be presented to a user via an interface (e.g., by displaying or otherwise communicating the determined at least one score to the user).

Applicants have recognized that it may be desirable, in accordance with some embodiments, to provide a user interface for assessing a severity of damage to property and/or providing recommendations of one or more actions based on information associated with a damage claim. In some embodiments, damaged property may be insured or otherwise associated with an insurance policy issued by an insurer to a customer. In some embodiments, damaged property being assessed for damage severity (e.g., by one insurer) may comprise third party property that may be insured (e.g., by a different insurer) or may not be insured.

In one embodiment, a user interface (e.g., provided via an application, such as a web browser, running on or presented via a computing device) allows for receiving information (e.g., from a claim professional, claimant, and/or other user; from a mobile device, telematics device, and/or a server computer) for determining one or more actions for evaluating, assessing, or appraising a damage claim. Alternatively or in addition, the determined recommendation(s) may be received from another computing device (e.g., a remote server) and/or may be presented to a user via an interface (e.g., by displaying or otherwise communicating a determined appraisal method to the user).

Various embodiments discussed in this disclosure allow for determining a recommended approach for appraising a damage claim in various insurance contexts (e.g., automobile insurance claims). Applicants have recognized that it may be desirable, in accordance with some embodiments, to enhance the appraisal decision making process to account for statistical evidence and/or to better leverage loss capture information in valuation and remediation decision making.

It should be understood that the embodiments described in this disclosure are not limited to use with a desktop computer (although some embodiments may be described with reference to such devices, for ease of understanding), but are equally applicable to any computing device, such as a mobile device, or a personal or client computer (e.g., in a user's home or office). Any embodiments described with reference to a desktop computer or user device in this disclosure should be understood to be equally applicable to any such other types of computing device, as deemed appropriate for any particular implementation(s).

In accordance with some embodiments of the present invention, one or more systems, apparatus, methods, articles of manufacture, and/or computer readable media (e.g., a non-transitory computer readable memory storing instructions for directing a processor) provide for one or more of: (i) establishing coefficients useful for assessing a severity of damage to insured property, (ii) managing damage claim appraisals for assessing a severity of damage to insured property, and/or (iii) providing a recommendation of one or more actions based on damage claim information associated with a damage claim. In some embodiments, at least one function or step may be performed via a user interface (e.g., presented via a display of a computing device). In one or more embodiments, assessing a severity of damage, managing damage claim appraisals, and/or providing a recommendation of one or more actions, may be based on damage claim information that does not include information from an in-person appraisal (e.g., by an appraisal professional).

Throughout the description that follows and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

As used in this disclosure, “appraisal”, “claim appraisal”, “damage claim appraisal”, and “damage appraisal” may be used synonymously and may refer to a process for appraising damaged property that may involve one or more of: (i) determining an estimate of loss to the value of damaged property, (ii) determining an estimate of the cost to repair or replace damaged property (e.g., to its condition prior to being damaged), and (iii) determining the current value of the damaged property (e.g., the value of a damaged automobile that was in an accident). According to some embodiments, an appraisal may be performed (e.g., by an appraisal professional) by conducting an in-person review of the damaged property (a “field appraisal”). According to one or more embodiments, an appraisal may be performed (e.g., by an appraisal management system, by a user via an appraisal management system) for damaged property that has not been appraised in person (e.g., based on damage claim information received from a claimant and/or a claim management system).

As used in this disclosure, “claim estimate”, “insurance claim estimate”, “repair estimate”, “damage estimate”, and “damage claim estimate” may be used synonymously and may refer to a determined value or cost (e.g., $3,000) to repair damaged property (e.g., to its condition prior to being damaged). A claim estimate, as discussed in accordance with some embodiments, may require an in-person assessment of damaged property in order to provide an estimated value of the damage or loss. In some embodiments, a damage estimate value may be compared to one or more predetermined threshold values for use in determining, for example, one or more recommended appraisal options. A claim estimate value may be determined, for example, by a contractor, repair shop, and/or an appraisal professional (e.g., employed by an insurer).

As used in this disclosure, an “assessment of damage severity” may refer, without limitation, to any score, rank, measurement, metric, or value, that may be useful in describing an amount, severity, scope, or extent of property damage. Unless explicitly stated otherwise, in this disclosure, an assessment of damage severity does not include a claim estimate value or amount determined by an in-person review of damaged property. According to some embodiments, an assessment of damage severity may refer to a score or severity description based on damage claim information that includes information associated with a damage claim (but not based on a monetary value of a claim estimate). Various examples of damage claim information are discussed in this disclosure. According to some embodiments, an assessment of damage severity may include an indication of “total loss” (e.g., a projection that the cost to repair a damaged vehicle to its pre-accident condition would exceed the actual value of the vehicle), a relative description of damage severity (e.g., “High”, “Low”, “Medium”, “Very Low”; “A”, “B”, etc.), and/or a score (e.g., −3, 5, 92, 1,047), as may be desired for a particular implementation.

As used in this disclosure, “computing device” may refer to, without limitation, one or more personal computers, laptop computers, set-top boxes, cable boxes, network storage devices, server computers, media servers, automatic teller machines (ATM), kiosks, personal media devices, communications devices, display devices, financial transaction systems, vehicle or dashboard computer systems, televisions, stereo systems, video gaming systems, gaming consoles, cameras, video cameras, MP3 players, mobile devices, mobile telephones, cellular telephones, GPS navigation devices, smartphones, tablet computers, portable video players, satellite media players, satellite telephones, wireless communications devices, personal digital assistants (PDA), point of sale (POS) terminals, credit card transaction systems, online or Internet purchase systems, and/or credit card or other financial account card transaction systems.

As used in this disclosure, “mobile device” and “portable device” may refer to, without limitation, a handheld computer, a wearable computer, a personal digital assistant, a cellular telephone, a network appliance, a camera, a smart phone, a network base station, a media player, a navigation device, a game console, or any combination of any two or more of such computing devices.

According to some embodiments, a client computer or other type of computing device may comprise one or more mobile devices, including but not limited to mobile telephones, cellular telephones, GPS navigation devices, smartphones such as a Blackberry™, Palm™, Windows™ phone, iPhone™ Galaxy S4™ by Samsung, HTC One™ by HTC, and tablet computers such as an iPad™ by Apple, Slate™ by HP, Ideapad™ by Lenovo, Xoom™ by Motorola, Kindle Fire™ by Amazon, or Nexus 7™ by Google, and other types of handheld, wearable and/or portable computing devices (e.g., a Google Glass™ wearable computing device by Google). Some type of users may find it beneficial to use a mobile device controlled in accordance with one or more of the embodiments described in this disclosure. In one example, a client computer may comprise a smartphone. Other types of computing devices are discussed in this disclosure, and still others suitable for various embodiments will be apparent to those of ordinary skill in light of this disclosure.

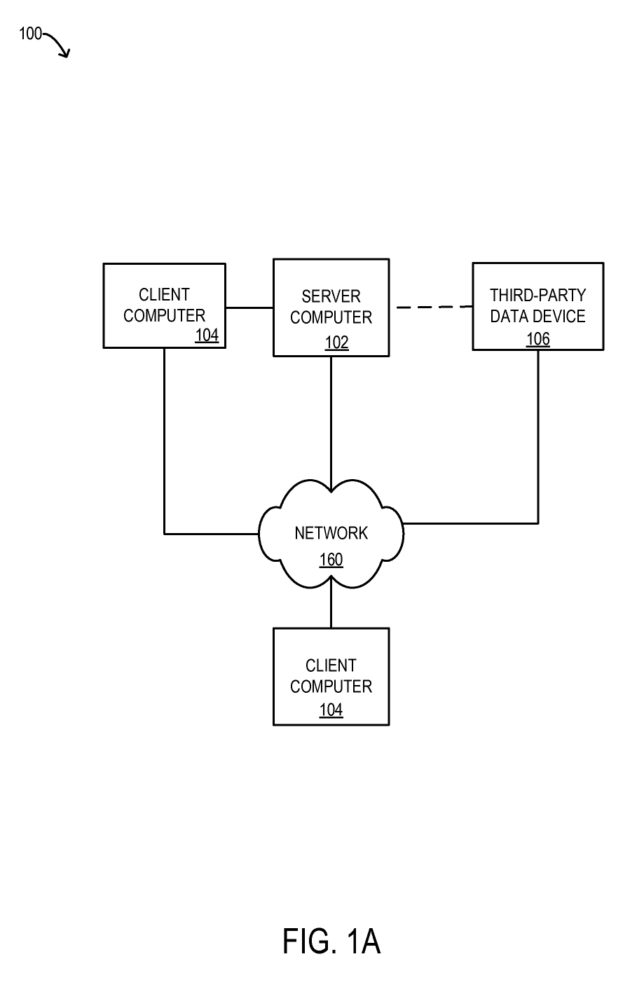

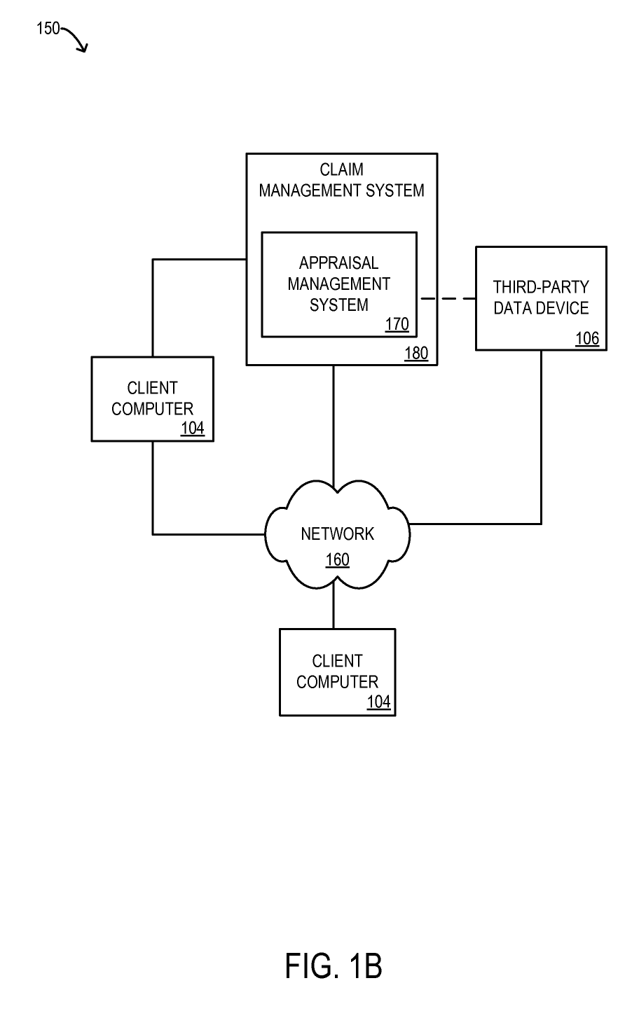

FIG. 1A depicts a block diagram of an example system 100 according to some embodiments. The system 100 may comprise one or more client computers 104 in communication with a controller or server computer 102 (e.g., a web server) via a network 160. Typically a processor (e.g., one or more microprocessors, one or more microcontrollers, one or more digital signal processors) of a client computer 104 or server computer 102 will receive instructions (e.g., from a memory or like device), execute those instructions, and perform one or more processes defined by those instructions. Instructions may be embodied, for example, in one or more computer programs and/or one or more scripts.

In some embodiments a server computer 102 and/or one or more of the client computers 104 receives (e.g., from a user), stores, and/or has access to data that is associated with one or more damage claims (e.g., automobile damage claims) and useful for assessing a recommended action for appraising a damage claim. Such information may include one or more of: (i) claim information (e.g., about a particular damage claim), (ii) historical claim data (e.g., for past damage claims of one or more insureds), (iii) options for appraising a damage claim (e.g., in-person appraisal by an insurance professional, a written estimate acquired by claimant), and/or (iv) one or more coefficients for use in managing damage claim appraisals (e.g., for use in determining a score, for use in determining an appraisal option for appraising a damage claim).

In one example, historical claim data and/or coefficients may be specific to one individual (e.g., a claimant), one vehicle, and/or one accident type. In another example, such information may be associated with more than one person, claimant, company, accident type, insured, state and/or other useful population, as desired for a particular implementation.

According to some embodiments, any or all of such data may be stored by or provided via one or more optional third-party data devices 106 of system 100. A third-party data device 106 may comprise, for example, an external hard drive or flash drive connected to a server computer 102, a remote third-party computer system for storing and serving data (e.g., GPS data, weather data, traffic data, telematics data) for use in performing one or more functions described in this disclosure, or a combination of such remote and/or local data devices. In one embodiment, one or more companies and/or end users may subscribe to or otherwise purchase data (e.g., coefficients data) from a third party and receive the data via the third-party data device 106.

In some embodiments, the server computer 102 may comprise one or more electronic and/or computerized controller devices such as computer servers communicatively coupled to interface with the client computers 104 and/or third-party devices 106 (directly and/or indirectly). The server computer 102 may, for example, comprise PowerEdge™ M910 blade servers manufactured by Dell, Inc. of Round Rock, Tex. which may include one or more Eight-Core Intel® Xeon® 7500 Series electronic processing devices. According to some embodiments, the server computer 102 may be located remote from the client computers 104. The server computer 102 may also or alternatively comprise a plurality of electronic processing devices located at one or more various sites and/or locations.

According to some embodiments, the server computer 102 may store and/or execute specially programmed instructions to operate in accordance with one or more embodiments described in this disclosure. The server computer 102 may, for example, execute one or more programs that facilitate assessing the severity of damage to insured property, via the network 160.

In some embodiments, a client computer 104, such as a computer workstation or terminal of a claim professional of an insurance company, may comprise a desktop computer (e.g., a Dell OptiPlex™ desktop by Dell, Inc.) or a workstation computer (e.g., a Dell Precision™ workstation by Dell Inc.), and/or a mobile or portable computing device such as a smartphone (e.g., the iPhone or iPad manufactured by Apple, the Blackberry manufactured by Research in Motion, or the Moto X manufactured by Motorola), a Personal Digital Assistant (PDA), cellular telephone, laptop (e.g., a Dell Latitude™ by Dell Inc.) or other portable computing device, and an application for assessing damage severity is stored locally on the client computer 104, which may access information (e.g., coefficient data) stored on, or provided via, the server computer 102. In another embodiment, the server computer 102 may store some or all of the program instructions for assessing damage severity and/or assessing or recommending appraisal options, and the client computer 104 may execute the application remotely via the network 160 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices (e.g., a desktop computer with a stand-alone application) without a central authority. In such an embodiment, any functions described herein as performed by a server computer and/or data described as stored on a server computer may instead be performed by or stored on one or more such devices, such as a client computer or table computer. Additional ways of distributing information and program instructions among one or more client computers 104 and/or server computers 102 will be readily understood by one skilled in the art upon contemplation of the present disclosure.

FIG. 1B depicts a block diagram of an example system 150 according to some embodiments. The system 150 may comprise one or more client computers 104 in communication with a claim management system 180 via a network 160. In one embodiment, a claim management system 180 may be hosted by, for example, a server computer 102. According to some embodiments, an appraisal management system 170 is integrated into a claim management system 180, for example, as a module, subsystem, or other functionality accessible through the claim management system 180.

In one embodiment, information about a particular claim, e.g., stored by claim management system 180 for managing insurance claims, may be provided advantageously to the appraisal management system 170. For example, stored information about a claimant, the insured property associated with an insurance policy, and/or other information from the claimant's file, may be accessible by the appraisal management system 170, without requiring manual input by a claim professional. As discussed above with respect to system 100 of FIG. 1A, in some embodiments one or more third-party data devices 106 may store information used in assessing the severity of damage to insured property (e.g., one or more predetermined coefficients and/or scores for generating a damage severity score).

According to one example system, an appraisal management system is integrated as a module or sub-system of a centralized management system, such as a property claim management system. Integration with a claim management system may allow advantageously for pre-filling, in a user interface, information retrieved from the claim management system, such as a claimant's name, claim number, state, and/or ZIP code, and may further provide for storing results of the appraisal management process(es) with the main claim file in the claim management system.

According to one example system, an appraisal management system includes a web service comprising an interface enabling communication between and among distributed applications. Web services typically enable cross-platform integration by enabling applications that are written in various programming languages to communicate by using a standard web-based protocol, such as Simple Object Access Protocol (SOAP). In one example, a client, such as a web application or desktop application, may communicate using SOAP and/or HTTP with a web service (e.g., using Java® or Microsoft®.NET code) and/or the web service may communicate with one or more servers such as a Teradata® Data Warehouse Appliance™ by Teradata Corporation, a SAS Stored Process Server™ or SAS® Metadata Server™ by SAS.

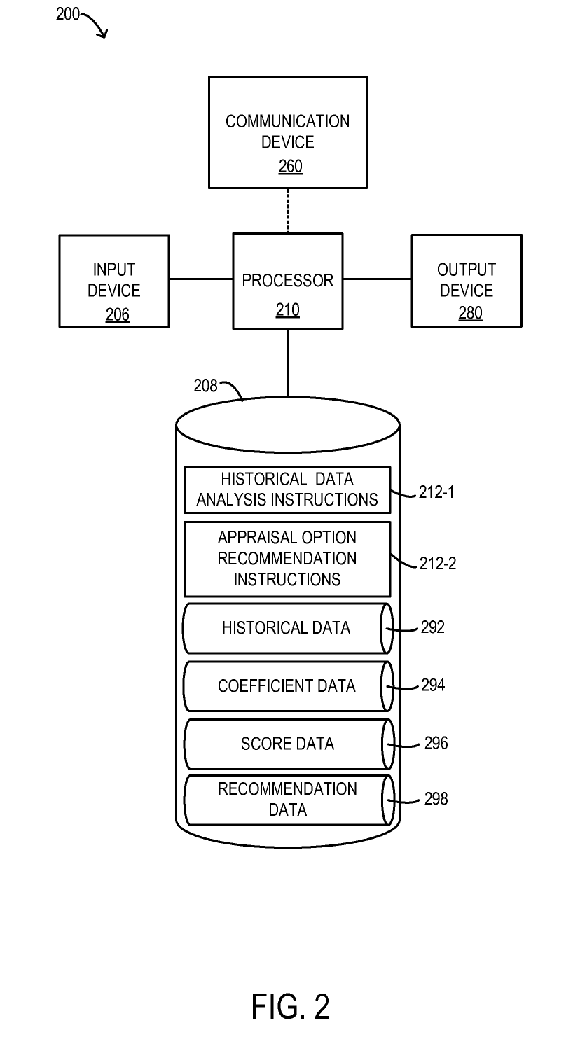

Turning to FIG. 2, a block diagram of an apparatus 200 according to some embodiments is shown. In some embodiments, the apparatus 200 may be similar in configuration and/or functionality to any of the client computers 104, server computers 102, third-party data devices 106, appraisal management system 170 and/or claim management system 180 of FIG. 1A and/or FIG. 1B. The apparatus 200 may, for example, execute, process, facilitate, and/or otherwise be associated with any of the processes described in this disclosure.

In some embodiments, the apparatus 200 may comprise an input device 206, a memory device 208 (e.g., a non-transitory computer readable storage device or other non-transitory computer readable medium), a processor 210, a communication device 260, and/or an output device 280. Fewer or more components and/or various configurations of the components 206, 208, 210, 260, 280 may be included in the apparatus 200 without deviating from the scope of embodiments described in this disclosure.

According to some embodiments, the processor 210 may be or include any type, quantity, and/or configuration of processor that is or becomes known. The processor 210 may comprise, for example, an Intel® IXP 2800 network processor or an Intel® XEON™ processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 900 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a physical and/or virtual keyboard that allows an operator of the apparatus 200 to interface with the apparatus 200 (e.g., such as to enter data or compose an electronic message). The input device 206 may comprise, for example, one or more of a pointer device (e.g., a mouse), a camera, and/or a headphone jack. Input device 206 may include one or more of a keypad, touch screen, or other suitable tactile input device. Input device 206 may include a microphone comprising a transducer adapted to provide audible input of a signal that may be transmitted (e.g., to the processor 210 via an appropriate communications link) and/or an accelerometer or other device configured to detect movement of the device.

The output device 280 may, according to some embodiments, comprise a display screen and/or other practicable output component and/or device. The output device 280 may, for example, provide an indication of a damage severity score or other assessment of damage severity and/or a recommended action or appraisal option, to an insurance claim professional (e.g., via a computer workstation).

Output device 280 may include one or more speakers comprising a transducer adapted to provide audible output based on a signal received (e.g., via processor 210).

According to some embodiments, the input device 206 and/or the output device 280 may comprise and/or be embodied in a single device, such as a touch-screen display.

In some embodiments, the communication device 260 may comprise any type or configuration of communication device that is or becomes known or practicable. The communication device 260 may, for example, comprise a network interface card (NIC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals to a server in communication with a plurality of handheld, mobile and/or telephone devices. According to some embodiments, the communication device 260 may also or alternatively be coupled to the processor 210.

Communication device 260 may include, for example, a receiver and a transmitter configured to communicate via signals according to one or more suitable data and/or voice communication systems. In some embodiments, the communication device 260 may comprise an IR, RF, Bluetooth™ and/or Wi-Fi® network device coupled to facilitate communications between the processor 210 and another device (such as one or more mobile devices, server computers, central controllers, and/or third-party data devices). For example, communication device 260 may communicate voice and/or data over mobile telephone networks such as GSM, CDMA, CDMA2000, EDGE or UMTS. Alternately, or in addition, communication device 260 may include receiver/transmitters for data networks including, for example, any IEEE802.x network such as Wi-Fi or Bluetooth™.

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 208 may, according to some embodiments, store one or more of historical data analysis instructions 212-1 (e.g., computer readable software code), appraisal option recommendation instructions 212-2, historical data 292, coefficient data 294, score data 296, and/or recommendation data 298. In some embodiments, any one or more the instructions 212-1 and/or 212-2 may be utilized by the processor 210 to provide output information via the output device 280 and/or the communication device 260 (e.g., via one or more user interfaces).

According to some embodiments, historical data analysis instructions 212-1 may be operable to cause the processor 210 to process historical data 292 (e.g., historical claim data, historical damage appraisal data, and/or historical accident data) as described in this disclosure. Historical data 292 received via the input device 206 and/or the communication device 260 may, for example, be data mined, analyzed, sorted, filtered, decoded, decompressed, ranked, scored, plotted, and/or otherwise processed by the processor in accordance with the instructions of historical data analysis instructions 212-1. In some embodiments, historical claim and/or damage appraisal information may be fed by the processor 210 through one or more mathematical and/or statistical equations and/or models in accordance with instructions of historical data analysis instructions 212-1 to define one or more coefficients (e.g., coefficient data 294), which may then be utilized for various purposes described in this disclosure.

According to some embodiments, the appraisal option recommendation instructions 212-2 may be operable to cause the processor 210 to perform an appraisal option assessment (e.g., for one or more damages claims) as described in this disclosure. Historical claim data 292 and/or coefficient data 294 may be analyzed to determine a recommended and/or optimal appraisal option for a given damage claim (e.g., for an automobile accident), such as by calculating or otherwise generating a score, such as one or more damage severity scores (e.g., a total loss factor score, and/or estimate review factor score). Historical data 292 and/or coefficient data 294 may be analyzed to determine at least one recommended action (e.g., from recommendation data 298) for whether and/or how to appraise the particular damage claim, and the recommended option may be indicated to a user (e.g., to a claim professional and/or claimant) as potentially useful in settling a damage claim efficiently.

In one example, a recommended appraisal option of having an insurance professional appraise property damage in person may be indicated to a claim professional, a claimant, and/or the appraiser. In another example, a recommended appraisal option of acquiring one or more damage estimates (e.g., a written repair estimate) from an external source (e.g., an auto repair shop, the claimant) may be indicated to a claim professional, a claimant, and/or a repair shop. In another example, a recommended appraisal option of declaring the insured property a total loss and recommending collection for salvage (e.g., towing a severely damaged vehicle to a salvage yard) may be indicated to a claim professional, a claimant, and/or a towing service.

The appraisal option recommendation instructions 212-2 may, in some embodiments, utilize the coefficient data 294 to calculate a score for a given damage claim. In some embodiments, such a score may be compared with one or more predetermined scores (or ranges of scores) to identify a recommended appraisal option. For example, if a total loss factor score is greater than a predetermined threshold score, the recommended option for a severely damaged vehicle may be to have the vehicle towed to a salvage yard (e.g., without first having an appraisal professional review the vehicle at its present location). In another example, if an estimate review factor score for a lightly damaged vehicle is less than a predetermined threshold score, the recommended option may be to have the claimant provide a repair estimate (e.g., without having an appraisal professional conduct an in-person damage appraisal) that may be reviewed (e.g., by or on behalf of the insurance provider to see if it is within a predetermined threshold estimate value).

According to some embodiments, the apparatus 200 may function as a computer terminal and/or server of an insurance provider, for example, that is utilized to process or manage insurance claims and assess a severity of damage and/or recommend appraisal options. In some embodiments, the apparatus 200 may comprise a web server and/or other portal (e.g., an interactive voice response unit (IVRU)) that provides historical data 292, coefficient data 294, score data 296, and/or recommendation data 298 to various types of users.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 or may simply be accessible to the apparatus 200 (e.g., externally located and/or situated).

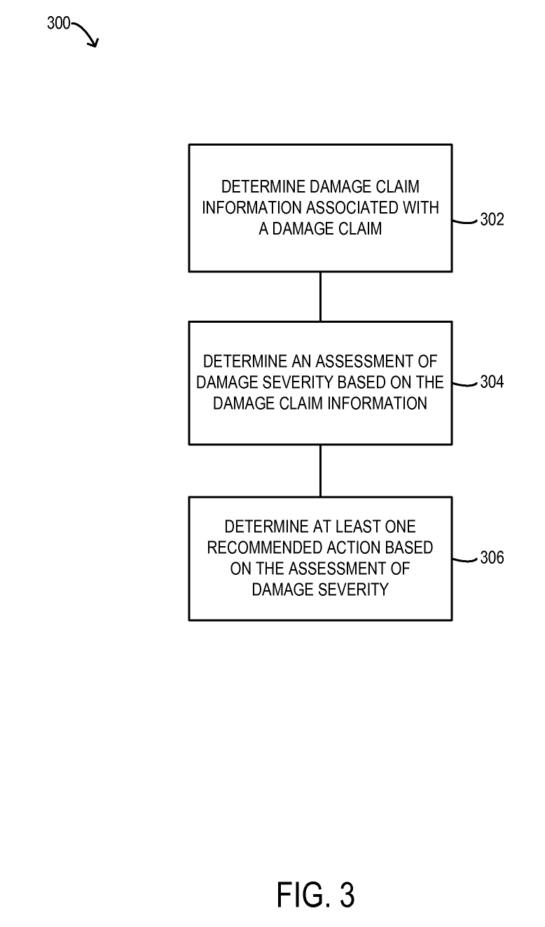

Referring now to FIG. 3, a flow diagram of a method 300 according to some embodiments is shown. The method 300 may, for example, be performed by or on behalf of an insurer, a claim professional, a claimant, and/or other type of user. It should be noted that although some of the steps of method 300 may be described herein as being performed by a client computer while other steps are described herein as being performed by another computing device, any and all of the steps may be performed by a single computing device, which may be a client computer, server computer, third-party data device or another computing device. Further, any steps described herein as being performed by a particular computing device may be performed by a human or another computing device as appropriate.

According to some embodiments, the method 300 may comprise determining damage claim information associated with a damage claim or property loss claim, at 302. In one embodiment, damage claim information may comprise claim, accident, claimant, and/or and vehicle information relevant to a particular damage claim (e.g., for an automobile accident). The information may comprise, for example, one or more of: claim information about an insurance claim, personal information about a claimant, information about circumstances of an accident or other loss event, and/or property information about the damaged property (e.g., information about a damaged vehicle).

Determining the information may comprise, in accordance with some embodiments, one or more of: accessing stored electronic data; receiving the information via a user interface (e.g., from a claim professional or other user) or input device, and/or receiving a signal including an indication of the information from a client computer, mobile device, web server, server computer, claim management system, and/or third-party data device. Damage claim information may be received (e.g., via a mobile device or other type of computing device) from a claimant (e.g., a driver involved in an accident), insurance professional, third party (e.g., an accident responder), and/or a sensor device (e.g., an in-vehicle telemetric device, a GPS-enabled device, a device comprising an accelerometer). Such information may be stored, in some embodiments, on a server computer.

According to some embodiments, the method 300 may comprise determining an assessment of damage severity based on the damage claim information, at 304. As discussed in this disclosure, a determination of the existence of certain conditions and/or characteristics associated with a damage claim may be useful, in some embodiments, for assessing the severity of damage to insured property in an accident or other loss event. In some embodiments, assessing the damage severity based on the damage claim information comprises determining a score or other indicia of severity. In some embodiments, determining a score may comprise looking up (e.g., in score data 296) respective factor scores corresponding to the particular circumstances of a damage claim, and calculating a damage severity score for the damage claim based on the respective scores. In one example, determining a score may comprise summing the respective scores for each of a plurality of factors described by the damage claim information (e.g., speed of a vehicle, time of day, age of the damaged vehicle) or otherwise quantifying them in accordance with a damage severity formula. In one example, each respective factor score may comprise or be associated with a particular weight or coefficient for use in a damage severity formula.

Although some of the examples provided in this disclosure relate to the calculation of total scores (e.g., a total damage severity score) based on a model using predetermined values for specific damage claim information factors, according to some embodiments an expected severity of damage (e.g., a damage severity score and/or an estimated monetary damage value) may be determined directly through a generalized linear model formula (e.g., derived based on historical data). In some embodiments, such a formula may be used for calculating an estimated monetary value of the loss. For example, the formula may be:

Estimated monetary damage value=ê(intercept+v₁+v₂^{+ . . . +v}ₙ),

where each variable (v₁ to vₙ) corresponds to a particular factor of the damage claim information (e.g., from coefficient data 294), and the intercept is a value (e.g., 7.06) derived for the generalized linear model formula (e.g., based on a regression analysis of historical claim data). Accordingly, for an example accident involving example factors of (i) front end damage at a parking lot accident site (corresponding to an example factor score of 0.06) and (ii) collision at a low speed of impact (corresponding to an example factor score of −0.23), the example damage severity formula may be used to determine a damage severity score as:

Estimated monetary damage value=ê(7.06+0.06+−(0.23))=˜$982.

In some embodiments, determining an assessment of damage severity may comprise one or more of: determining a total loss factor score for evaluating whether there is a total loss (from an insurance perspective) and/or determining an estimate review factor score for evaluating whether a claim is eligible for an estimate review processing option (e.g., an appraisal option that may not require a field appraisal by an appraisal professional).

According to some embodiments, the method 300 may comprise determining at least one recommended action based on the assessment of damage severity. In one embodiment, the damage severity assessment (e.g., a damage severity score) may be compared to one or more predetermined thresholds for recommending one or more appraisal options. For example, a relatively high damage severity score that exceeds a total loss threshold may indicate a projected damage estimate that would exceed the value of the property (a total loss), and an option for towing a damaged vehicle to a salvage location may be recommended (e.g., instead of having a field appraisal at the vehicle's current location). In another example, a relatively low damage severity score that is less than an estimate review threshold may lead to a recommendation of an estimate review process, in which no field appraisal by an appraisal professional is required (e.g., pending review of a damage estimate made by a repair shop).

As discussed in this disclosure, a determination of the existence of certain conditions and/or characteristics associated with a damage claim, may be useful, in some embodiments, for determining preferred option for appraising a damage claim (e.g., assessing the monetary value of insured property and/or property loss). According to some embodiments, a method may comprise (i) determining at least one coefficient associated with a data parameter (e.g., a particular vehicle, claimant, or accident characteristic) and/or (ii) generating a score or other indication of expected loss (e.g., indicative of whether the claimed property damage is expected to be relatively high or low, based on one or more coefficients).

According to some embodiments, a method may comprise determining at least one recommended appraisal option based on the expected loss. Various ways of determining recommendation appraisal options and various types of recommended actions are discussed in this disclosure, and others will be apparent to those skilled in the art upon contemplation of this disclosure.

In some embodiments, a determined indication of expected loss or other projected measure of damage severity and/or at least one recommended appraisal option, may be communicated to a client computer, server computer, third-party data device, and/or to a claim professional or other user (e.g., represented on a display device of a computer workstation or mobile device).

According to some embodiments, assessing damage severity may comprise determining information including, without limitation, an indication of a site of an accident, a primary point of damage (e.g., to a damaged vehicle), an indication of speed of a vehicle at impact, and/or an indication of a collision object type (e.g., a type of object that a damaged vehicle struck). According to some embodiments, each respective type of accident, point of damage, speed or speed range, and/or collision object type, may be associated with a particular score (e.g., as indicated in score data 296). Assessing damage severity and/or determining at least one recommendation for an appraisal option may comprise determining a respective score for various factors or items of information associated with a damage claim, and calculating a damage severity score based on the respective scores corresponding to the damage claim information. According to some embodiments, a collision object type may refer to a category of object (e.g., pedestrian, animal, stationary object) and/or to a specific type of object (e.g., jogger, deer, building). According to some embodiments, a stationary object type is an example of a collision object type and may describe a category of stationary objects (e.g., major, minor, building) and/or to a specific type of stationary object (e.g., road debris, mailbox, tree, utility pole, residential dwelling).

According to some embodiments, a method that may be performed, for example, by a computerized processing device (e.g., a client computer, a server computer) may comprise one or more of the following functions: (i) determining information relating to a damage claim associated with damaged insured property, the information comprising a plurality of factors; (ii) determining a respective score for each factor of the information relating to the damage claim; (iii) determining a damage severity score for the damage claim based on the respective scores; (iv) determining at least one recommended appraisal option based on the damage severity score; and (v) transmitting (e.g., via a user interface) an indication of the at least one recommended appraisal option. According to some embodiments, a non-transitory computer readable memory may store instructions that when executed (e.g., by a processor of a specially-programmed computerized processing device) result in one or more of the preceding example functions.

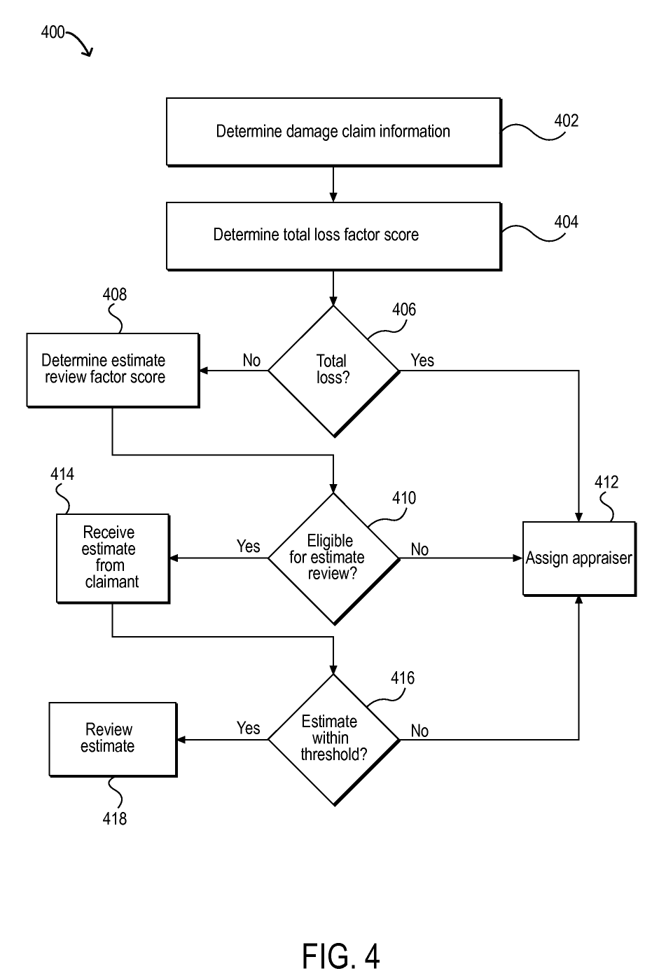

Referring now to FIG. 4, a flow diagram of a method 400 according to some embodiments is shown. The method 400 may, for example, be performed by or on behalf of an insurer, a claim professional, a claimant, and/or other type of user. It should be noted that although some of the steps of method 400 may be described herein as being performed by a client computer while other steps are described herein as being performed by another computing device, any and all of the steps may be performed by a single computing device, which may be a client computer, server computer, third-party data device or another computing device. Further, any steps described herein as being performed by a particular computing device may be performed by a human or another computing device as appropriate.

According to some embodiments, the method 400 may comprise determining damage claim information, at 402, and determining a total loss factor score (e.g., based on the damage claim information), at 404. In one example, determining the total loss factor score comprises generating a score for the damage claim using respective weights or factor scores (e.g., stored in score data 296) assigned to particular claim factors for the specific purpose of total loss analysis. In one example, damage claim information for the damage claim may be analyzed to determine a plurality of respective total loss factor scores, and the plurality of factor scores may be summed or otherwise used to generate a total loss factor score for the damage claim as a whole.

According to some embodiments, the method 400 may comprise determining whether the property loss is a total loss, at 406. Determining whether a loss is a total loss may comprise determining whether a total loss factor score exceeds a predetermined total loss threshold value.

Applicants have recognized that, based on analysis of historical data, some types of accident factors, such as fire damage, a vehicle rollover, and water damage, indicate a higher likelihood of total loss. Accordingly, in accordance with some embodiments, the presence of such factors may correspond to factor scores or weights relatively high enough to ensure a total loss factor score that projects a total loss (e.g., that exceeds a total loss threshold). In one embodiment, one or more particular items of damage claim information may dictate (e.g., in accordance with criteria of appraisal option recommendation instructions 212-2) whether a loss is a total loss (e.g., irrespective of other characteristics of an accident). For example, certain types of damage (e.g., fire or water damage), if present, may result in a loss being projected (prior to a field appraisal) as a total loss.

If a total loss is projected (e.g., based on the total loss factor score), the method 400 may comprise assigning an appraiser (e.g., a field appraiser employed or contracted by an insurer to conduct a field appraisal), at 412, and/or recommending a damaged vehicle be towed to a salvage facility (where a field appraisal may confirm the projected total loss).

According to some embodiments, if at 406 the loss is not projected to be a total loss, the method 400 may comprise determining an estimate review factor score (e.g., based on the damage claim information), at 408. In one example, determining the estimate review factor score comprises generating a score for the damage claim using respective weights or factor scores (e.g., stored in score data 296) assigned to particular claim factors for the specific purpose of estimate review factor analysis. In one example, damage claim information for the damage claim may be analyzed to determine a plurality of respective estimate review factor scores, and the plurality of factor scores may be summed or otherwise used to generate an estimate review factor score for the damage claim as a whole.

According to some embodiments, the method 400 may comprise determining whether the damage claim is eligible for an estimate review process (e.g., based on the estimate review factor score), at 410. Determining whether the damage claim is eligible may comprise determining whether an estimate review factor score does not exceed a predetermined estimate review threshold value.

Applicants have recognized that, based on analysis of historical data, some types of vehicle accident factors, such as the involvement of injuries, comprehensive losses, non-drivable or towed vehicles, multiple points of damage, airbags being deployed, and/or glass damage, tend to correspond to a relatively severe damage not appropriate for an estimate review process (i.e., for which a field appraisal or some other appraisal option is appropriate). Accordingly, in accordance with some embodiments, the presence of such factors may correspond to factor scores or weights (e.g., stored in score data 296) relatively high enough to ensure an estimate review factor score that projects more severe damage and/or ineligibility for an estimate review process (e.g., that exceeds an estimate review threshold). In one embodiment, one or more particular items of damage claim information may dictate (e.g., in accordance with criteria of appraisal option recommendation instructions 212-2) whether a damage claim is ineligible for estimate review (e.g., irrespective of other characteristics of an accident). For example, certain types of damage claims (e.g., those involving injured persons), may automatically disqualify a damage claim from an estimate review process appraisal option.

According to some embodiments, as discussed in this disclosure, a determined damage severity score may be used for assessing whether damage is projected to be a total loss and/or whether a damage claim is eligible for an estimate review process. In some embodiments, scores, points, or weights corresponding to particular items of damage claim information may be different depending on whether a total loss or estimate review assessment is being made (e.g., based on statistical analysis and corresponding coefficient data). For example, a highway accident site may correspond to a score of 800 for purposes of assessing total loss, but may have a value of 200 for purposes of assessing whether a damage claim qualifies for estimate review. Alternatively or in addition, a predetermined threshold for comparing with a damage severity score (e.g., a total score taking into account a plurality of damage claim information items) for assessing total loss may be different than a predetermined threshold for determining whether a damage claim qualifies for estimate review.

The following example provides some example damage claim information related to an example damage claim, and indicates corresponding example scores, points, or weights associated with the particular items of information:

Accident site=Secondary road: 100

Primary point of damage=Rear: −400

Speed at impact=10-20 mph: 150

Stationary object type=Not applicable: 0.

Summing the respective scores gives a total damage severity score of −150. Depending on the particular implementation (e.g., in accordance with appraisal option recommendation instructions 212-2), the damage severity score may indicate a projection that a damage appraisal (were one performed) would likely find a relatively low severity of damage. For example, the example damage severity score may be less than a predetermined threshold (e.g., 200) and may therefore qualify for an appraisal option in which the user has the option to submit an estimate and the insurance provider does not first assign an appraisal professional for a field appraisal of the damaged vehicle (e.g., an “estimate review” option).

In another example, if the circumstances of the accident were different such that the calculated total damage severity score was 500, exceeding an example threshold of 200, then the claim may not be eligible for an estimate review option because the model would have predicted more severe damage. In such a case the system may recommend, for example, an in-person appraisal of the damage by an appraisal professional. In another example, the claim may have qualified as a total loss by exceeding an example threshold of 490.

If a damage claim is not eligible for estimate review (e.g., based on the estimate review factor score), the method 400 may comprise assigning an appraiser (e.g., to conduct a field appraisal), at 412. If the damage claim is eligible for estimate review, an estimate may be requested from a claimant and/or the claimant may be asked if he or she would like to participate in an estimate review process (e.g., forgoing, at least initially, a field appraisal option). The method 400 may comprise receiving an estimate from or on behalf of a claimant, at 414, and determining whether the damage estimate is within a predetermined estimate threshold, at 416. For example, the damage estimate (e.g., as determined by a repair shop) may be compared with a maximum estimate threshold. If the damage estimate exceeds a threshold (e.g., the damage estimate indicates a level of damage severity greater than was projected based on the estimate review factor score), then an appraiser may be assigned (e.g., the claim is removed from the estimate review process). If the estimate is within the predetermined threshold, then the method 400 may comprise reviewing the estimate (e.g., by an insurance professional). In some embodiments, reviewing the estimate may comprise ensuring that the estimate complies with one or more criteria and/or there is sufficient documentation and/or other evidence to support the damage estimate.

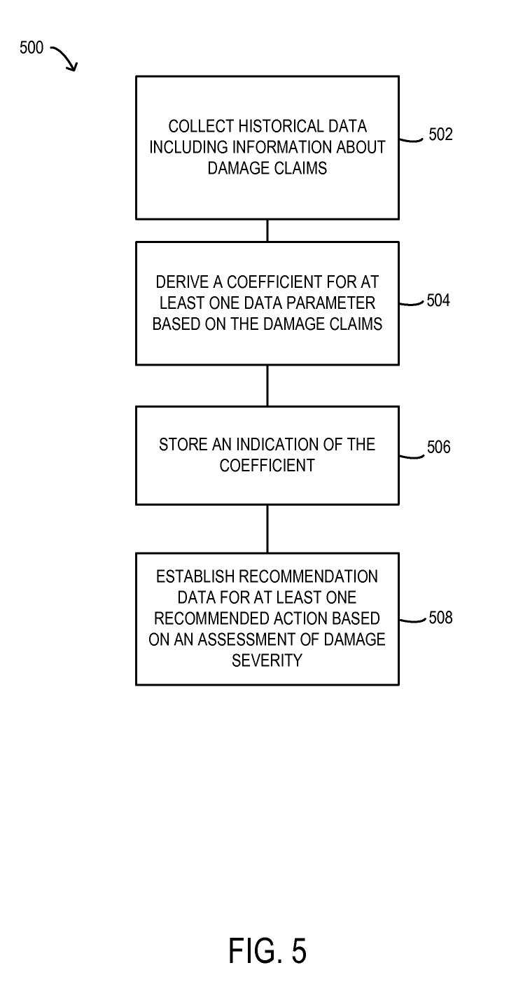

Referring now to FIG. 5, a flow diagram of a method 500 according to some embodiments is shown. The method 500 may, for example, be performed by or on behalf of an insurer, a claim professional, and/or a claimant or other user, in order to establish one or more types of information (e.g., in one or more databases) that may be useful, in one or more embodiments, in assessing an indication of expected property loss or other assessment of damage severity (e.g., a score). It should be noted that although some of the steps of method 500 may be described herein as being performed by a server computer, while other steps are described herein as being performed by another computing device, any and all of the steps may be performed by a single computing device which may be a client computer, server computer, third party data device or another computing device. Further any steps described herein as being performed by a particular computing device may be performed by a human or another computing device as appropriate.

In some embodiments method 500 may comprise collecting historical data including, without limitation, information about property loss, accidents, damage appraisals (e.g., by insurance professionals and/or third party assessors), claimants, vehicles, and/or repair shops, at 502. For example, historical claim and/or claimant information stored by one or more insurance companies may be selected and/or aggregated.

In some embodiments, the method 500 may comprise deriving a coefficient for at least one data parameter (e.g., a particular characteristic of a vehicular accident) based on information about the damage claims, including, without limitation, selected historical information about accidents and loss information, at 504. The method 500 may comprise storing an indication of the at least one coefficient (e.g., as coefficient data 294), at 506.

Deriving the at least one coefficient may comprise, for example, identifying records in the collected historical data indicating one or more particular conditions. Controlling for such variables, using well known techniques for statistical analysis, a coefficient for a given data parameter may be determined (e.g., by or on behalf of an insurance company) to represent, for example, variation from property loss experienced by other claimants (e.g., other automobile policy insureds) without that condition. Some data analysis techniques for identifying significant variables and/or controlling for variables to derive coefficients and other quantitative and qualitative descriptions of relationships among data populations are described in Tamhane and Dunlop, Statistics and Data Analysis from Elementary to Intermediate, Prentice Hall (2000) and in Kamber, M., Data mining: Concepts and Techniques, Morgan-Kaufman (2000), each of which is incorporated herein by reference. In some embodiments, claimant, accident and/or vehicle segmentation and other data analysis, data management, and data mining processes may rely on and/or adapt commercially available processes and products, such as the STATISTICA suite of analytics software products by StatSoft, Inc.

The particular values of coefficients described in this disclosure may be expressed as any value appropriate for assessing the effect of one or more conditions or characteristics associated with a damage claim on determining an optimal appraisal method for handling the claim. According to some embodiments, appropriate coefficients may be stored as percentages, ratios, values equal to, greater than, or less than 1.00, and/or other mathematical equivalents suitable for a desired implementation.

According to some embodiments, deriving coefficients may comprise examining historical data (e.g., stored in a database) and creating a binary variable such that the variable takes a value of 1 if a given claimant has experienced at least a threshold amount of property loss and value of 0 if the loss experienced by the claimant (e.g., a particular monetary valuation of the loss) was less than the threshold amount of loss. The binary variable for threshold loss value may be added to a dataset that contains variables that contain data on other characteristics of claimants, such as type of vehicle, accident conditions, etc. The dataset may then be analyzed as input to a commercial statistical software package (e.g., SAS® software) in order to estimate the relationship between the claimant characteristics and the expected property loss value to be predicted.

As noted above, numerous classes of techniques may be used to estimate the relationship, such as binary response models based on the principle of maximum likelihood (commonly known as logit or probit models), decision tree models, and neural networks. A generalized linear model is a generalization of the linear regression model such that (1) nonlinear, as well as linear, effects can be tested (2) for categorical predictor variables as well as for continuous predictor variables, using (3) any dependent variable whose distribution follows several special members of the exponential family of distributions (e.g., gamma, Poisson, binomial, etc.), as well as for any normally-distributed dependent variable. In the logit regression model, the predicted values for the dependent or response variable will never be less than (or equal to) 0, or greater than (or equal to) 1, regardless of the values of the independent variables. The logit regression model is, therefore, commonly used to analyze binary dependent or response variables.

With respect to other types of analytic procedures, decision tree models, such as classification and regression trees, are analytic procedures for predicting the values of a continuous response variable (e.g., vehicle make/model) or categorical response variable from continuous or categorical predictors. When the dependent or response variable of interest is categorical in nature, the technique is referred to as classification trees; if the response variable of interest is continuous in nature, the method is referred to as regression trees. For classification problems, the goal is generally to find a tree where the terminal tree nodes are relatively “pure,” i.e., contain observations that (almost) all belong to the same category or class. For regression tree problems, node purity is usually defined in terms of the sums-of-squares deviation within each node. At each step, the program will find a logical split condition to assign observations to the two child nodes; for continuous predictors these logical conditions are usually of the type: If x>Value then NodeID=k; for categorical predictors, the logical split conditions are usually of the type: If x=Category I then NodeID=k.

Neural networks are analytic techniques modeled after the (hypothesized) processes of learning in a cognitive system and the neurological functions of the brain, and capable of predicting new observations (on specific variables) from other observations (on the same or other variables) after executing a process of so-called learning from existing data.

Once a relationship between, for example, expected property loss valuation and one or more types of claim characteristics is estimated, a user (e.g., using a computer program) can enter one or more characteristics of a damage claim (e.g., via a user interface such as a web-based form or questionnaire) at or around the time, for example, a claim is reported (e.g., by a claimant) and before an appraisal professional has been allocated or has visited the site of the property damage (e.g., for an on-site damage appraisal). Based on the input characteristics associated with the claim, a computing device (e.g., a computer workstation, a server) may then calculate a score indicating one or more of: (i) whether the associated property damage has a higher likelihood of being appraised at or above a predetermined threshold value, (ii) whether an on-site appraisal should be performed by an insurance appraisal professional, and/or (iii) whether a damage estimate should be acquired (e.g., by the claimant, by an insurance claim professional, by the insurance provider) from an external source (e.g., a written estimate should be prepared by an automobile repair shop).

Many different types of characteristics, factors, and information related to a property loss or damage claim may be determined and/or analyzed in accordance with statistical techniques. Some examples of such damage claim information may include, without limitation:
Vehicle characteristics
Type of vehicle
Vehicle make/model/model year
Mileage on vehicle (e.g., 0-14,999, 15,000 and over)
Prior accident history
Current location of vehicle
Damage characteristics
Location of primary damage (e.g., driver center, passenger rear corner, etc.)
Location of secondary damage
Extent of damage
Number of vehicles involved in accident
Accident description
Accident/Damage type/Cause of loss (e.g. collision with object, hail, flood, etc.)
Point(s) of impact on vehicle
Speed of vehicle at impact
Number of airbags deployed
Type of collision object struck (e.g., debris in roadway, pothole road defect, pedestrian/cyclist)
Whether there were any fatalities
Whether there were any injuries
Whether there was an ambulance on scene
Number of occupants in vehicle and possible accident related injuries
Height of water
Type of water
Glass damage
Whether vehicle is drivable or not
Other characteristics
Claimant characteristics
Ability of claimant to obtain estimate
Customer preference for obtaining estimate
Reason(s) vehicle is not drivable
Accident characteristics
Accident location (e.g., intersection, parking area, highway/interstate, entrance/exit to highway/interstate, secondary road)
Weather conditions (e.g., at time of accident)
Road conditions
Light conditions
Emergency personnel at scene of accident
Insurance characteristics
Insurance coverage type (e.g., collision, comprehensive, rental, tow, etc.)
Towing and/or storage fees applicable at vehicle's current location

Coefficients representing the presence of different data parameters and/or multiple such parameters may be derived similarly by analyzing the historical data associated with damage claims associated with certain conditions or characteristics in light of the damage appraisal data associated with claims without such conditions or characteristics (e.g., comparing a population of claims having both characteristics A and B with another population of claims without both of those characteristics). Such coefficients may be stored, in some embodiments, as coefficient data in one or more databases.

In some embodiments method 500 may comprise establishing recommendation data for at least one recommended action (e.g., in recommendation data 298) based on an expected property loss value and/or other type of damage severity assessment (e.g., for an automobile damage claim). One or more actions may be established in association with one or more predetermined scores (or other measure of expected property loss value). In some embodiments, no actions may be recommended if a score determined for a particular claim does not exceed a predetermined threshold. In one example, a score less than 0.6 may be considered an indication of a “low” expected property loss value, and a score equal to or greater than 0.6 may be considered an indication of a “high” expected property loss value. Of course, any number of gradations, tiers, or ranges for indicating expected property loss value may be provided for (e.g., high, medium, and low), with one or more respective corresponding recommended actions, as desired for any particular implementation.

Recommended actions or appraisal options may be presented, as discussed with respect to various embodiments in this disclosure, to claim professional of an insurance carrier assigned to a claim and/or to a claimant.

According to some embodiments, an appraisal (e.g., a field inspection of accident damage) may be associated with a corresponding cost per unit (or average cost per unit). Contributing costs may include, without limitation, one or more of: salary, benefits, transportation, software, hardware, and/or miscellaneous expenses.

According to some embodiments, one or more metrics may be derived for use in optimizing appraisal management. In one example, a number of appraisals may be determined per unit of time (e.g., average number of appraisals per appraiser per day). In another example, average payouts for certain types of losses (e.g., vehicle accidents) may be determined (e.g., for use in determining or scoring expected property loss values). In another example, average appraisal values for certain types of losses may be determined. Such metrics may be useful, in accordance with one or more embodiments, for optimizing appraisal management (e.g., determining whether an onsite appraisal or a settlement based on a written estimate may be more cost effective for an insurance provider).

One or more of the methods described in this disclosure may involve one or more user interfaces. In some embodiments, a method may include providing an interface through which a user may be allowed to enter one or more of an identifier that identifies a claim and/or any other information about a claim, person, vehicle, claimant, property, or accident associated with a claim.

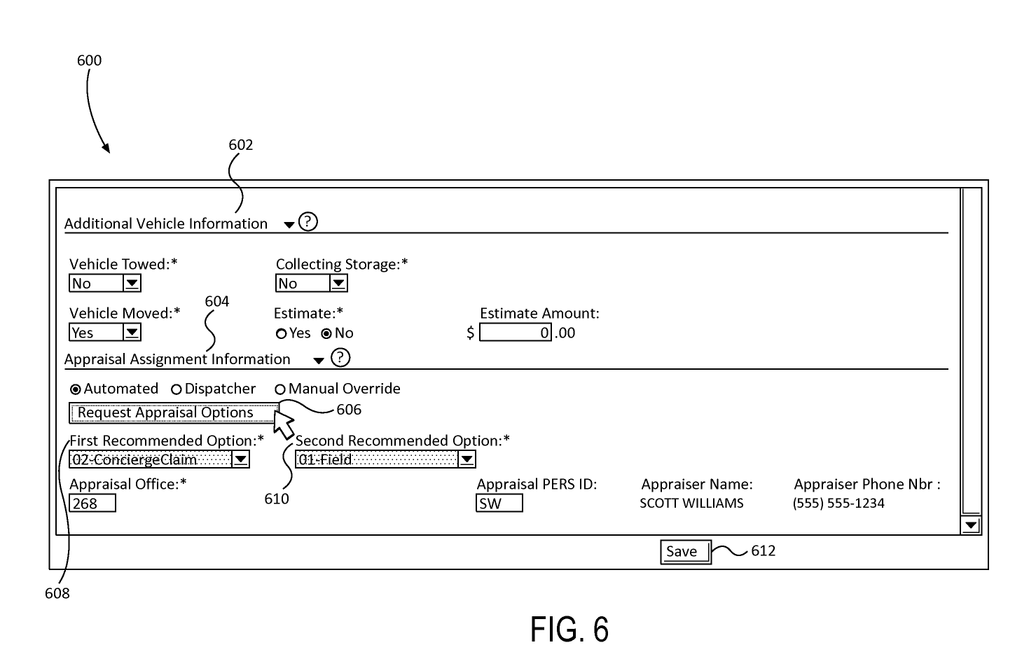

FIG. 6 illustrates an example interface 600 through which a user (e.g., a claim professional), computer, and/or an application may determine an assessment of damage severity and/or determine at least one recommendation for an appraisal option (e.g., total loss/tow, estimate review, field appraisal). In particular, a user may enter, change, receive, and/or transmit information about a damage claim, such as one or more of: vehicle information 602, appraisal assignment information 604, and/or recommended appraisal options 608, 610. For example, as illustrated in example interface 600, an indication of whether a vehicle was towed or moved, whether an estimate has been received, and/or an estimate amount may be input, entered, changed, and/or received. The interface 600 further includes a button 612 for saving the indicated information. As discussed in this disclosure, in some embodiments a claim number may be input to a process of a web service that uses the claim number to retrieve related information stored in one or more datasets and returns the retrieved information to the interface 600 (e.g., filling in one or more of the example fields of interface 600).

Example interface 600 further includes an example button 606 for requesting one or more appraisal options and/or initiating determination of one or more assessments of damage severity. According to some embodiments, in response to a user clicking on the button 606, one or more methods discussed in this disclosure may be initiated. For example, clicking on the button 606 may initiate determining at least one damage severity score and, based on the one or more damage severity scores, recommending at least one appraisal option.

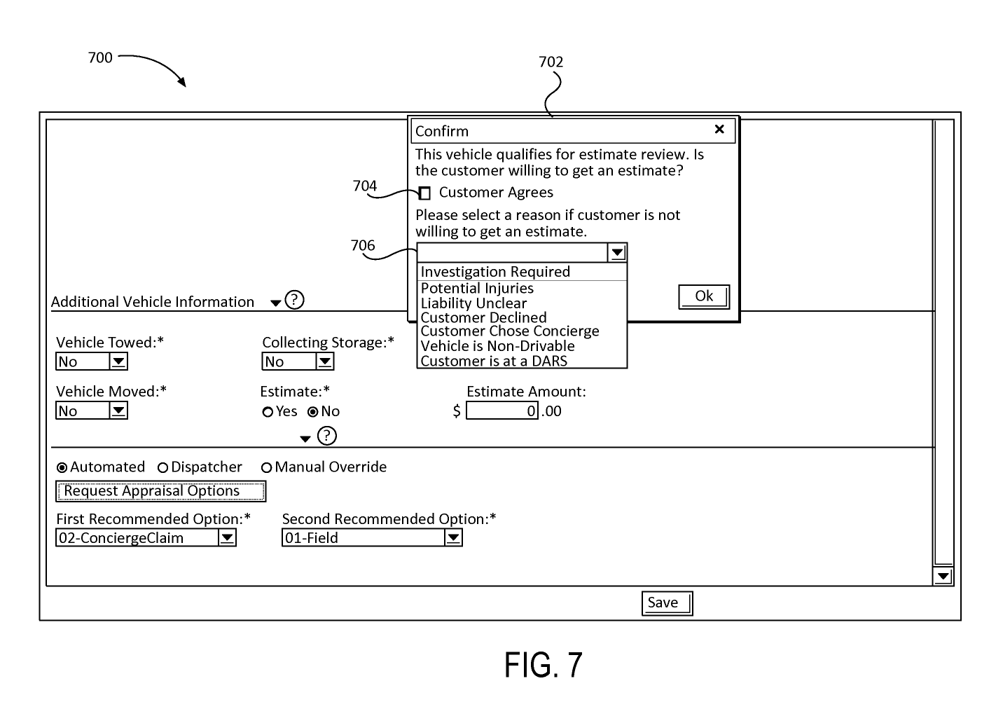

FIG. 7 illustrates an example interface 700 for transmitting an indication of an assessment of damage severity and/or a recommended appraisal option. The confirmation message 702 indicates that based on a determined damage severity score (e.g., an estimate review factor score), the vehicle corresponding to the damage claim qualifies for an estimate review process appraisal option. For example, if an estimate review factor score does not exceed an estimate review threshold value (e.g., indicating a projection of low to moderate damage based on damage claim information), the interface may (e.g., in accordance with appraisal option recommendation instructions 212-2) display the confirmation message 702. A user may indicate (e.g., based on a conversation or other communication with a user) at 704 whether the customer agrees to the estimate review process. The interface 700 also allows a user to input a reason 706 if the customer does not wish to get an estimate for the estimate review process.

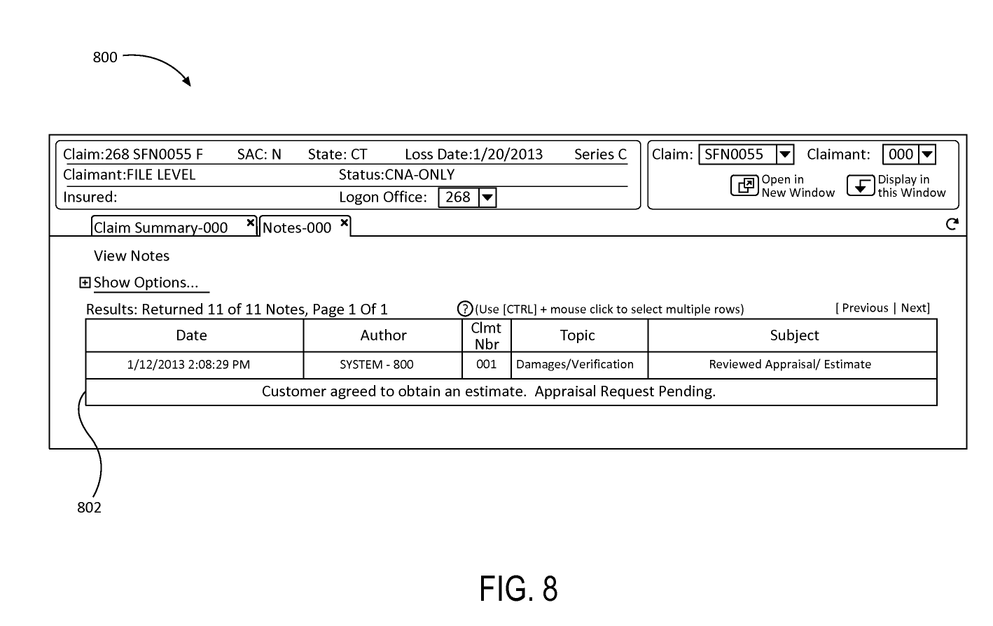

FIG. 8 illustrates an example interface 800 for providing an indication of a recommended appraisal option. For example, for an example claim “SFN0055”, a notes tab interface element indicates at 802 that the corresponding customer has agreed to obtain an estimate, and that any appraisal request is pending receipt of the estimate.

According to one example method, a user (e.g., a claim professional) responsible for handling a claim for an automobile policy claim accesses (e.g., using a smartphone, desktop, or laptop computer) a user interface for recommending an optimal appraisal method with respect to a claim. The user interface may be implemented, for example, as a spreadsheet in a spreadsheet application, as a smartphone application, as a web-based application, and/or as a component or module of a centralized claim data entry system. The interface, according to the example, includes form fields and/or other interface elements allowing the claim professional to enter data associated with the claim (e.g., in a questionnaire format).

Continuing with the example method, the user initiates a scoring method via the web service (e.g., by clicking a corresponding button of the user interface). The scoring method takes one or more fields from the front-end interface as input, creates binary variables pertaining to ranges and/or values expected by a scoring model, applies factors to the data, and determines a score indicative of an expected value of the claimed property loss (e.g., using a regression method). The method further may include returning a set of a recommended appraisal actions (e.g., indicating appraisal by an insurance company appraiser is necessary if the determined score is “High”). The score may be indicated to the user (e.g., displayed via the interface). Continuing with the example method, the user may initiate a save method of the web service (e.g., by clicking a corresponding button element of the interface) and the save method may take all fields from the front-end interface, as well as the score and any user-selected activities, as input, and save a corresponding record including the information to a dataset (e.g., stored in a Teradata® Data Warehouse Appliance™).

According to some embodiments, appraisal management and/or decision making about appropriate appraisal methods for a claim may be performed faster, in real-time, or approaching real-time. In one example, information about an accident may be received from a vehicle, driver, claimant, accident responder, and/or mobile device upon or shortly after an accident (e.g., a vehicle accident). In one example, information from a telematics device in a vehicle may transmit (e.g., automatically) relevant information that may be utilized (e.g., by a server) to determine an option for appraising the damage. In one example, a person on the scene of an accident (e.g., a driver) may input information via a smartphone application, and the information is transmitted to a server for use in making an appraisal decision. In one example, an insured may receive (e.g., via email, via a smartphone application) an indication shortly after an accident of a settlement amount, that a staff appraisal by an insurance professional is necessary, or that the insurance company is requesting that the insured acquire or have submitted a written estimate for repairing the damage. In one example, a claimant may receive (e.g., based on the claimant's current location via GPS, based on the claimant's home address) an indication of one or more locations (e.g., auto repair shops) at which the claimant may be able to acquire a written estimate.

According to some embodiments, information associated with an accident, vehicle, claimant, and/or other information associated with a claim may be collected by, accessible via, transmitted by, stored by, and/or received from a telematics device. According to some embodiments, some types of information that could be determined via a telematics device may include, without limitation one or more of: location, traffic conditions, speed, acceleration, time of day, braking, swerving, seat belt usage, vehicle maintenance (e.g., tire pressure, engine light, other monitoring lights/warnings), airbag deployment, an identifier that identifies a driver (e.g., a unique driver ID that indicates who was driving at the time of an accident), driver fatigue, turn signal usage, tailgating, distracted driving, total driving time, weather, odometer reading, cruise control setting, road conditions, etc.

According to some embodiments, a telematics data system allows for telematics data to be transmitted from a telematics device in each of one or more vehicles through a network to an insurance company computer system and, optionally, to one or more of a monitoring service computer system, and a data service provider computer system. Any such computer systems may have an arrangement similar to the exemplary system described above and may contain one or more apparatuses similar to the exemplary apparatus described above. Other arrangements may also be used. It is understood that telematics data systems according to some embodiments may include any number of vehicles and/or vehicles of one or more types.

In one embodiment, the telematics data is transmitted directly to an insurance company computer system, where the data is processed and analyzed (e.g., for determining an expected loss value and/or for determining a recommended appraisal option). In another embodiment, the data is transmitted first to a monitoring service computer system where it is processed. The processed data is then transmitted to the insurance company computer system where it is analyzed. In yet another embodiment, the telematics data is transmitted from the monitoring service computer system to the data service provider computer system, where it is combined with other data, including third-party data, before being transmitted to the insurance company computer system. In other embodiments, the telematics data may be transmitted to one or more of computer systems simultaneously.

In some embodiments, a telematics device may measure data items directly from a vehicle. In one example, the telematics device may communicate with a vehicle's onboard diagnostic (OBD) computer, such as through the OBD port (e.g., OBD-II port) or comparable electrical connection. Such systems may allow the direct measurement of many aspects of the vehicle and its operation. Other connections allowing direct vehicle measurements may also be used. In such embodiments, the data may be actively transmitted by the telematics device or it may be read from the device, such as by an RFID scanner or other scanner, for example, as the vehicle passes by the scanner.

In other embodiments, a telematics device may provide information regarding the vehicle and/or its operation by being present in the vehicle and transmitting a signal while the vehicle is operated without a connection to any vehicle system. In one example, such a device may comprise one or more of a global navigation satellite system (GNSS) device, such as a global positioning system (GPS) device, a mobile phone or personal portable electronic device, an accelerometer, an RFID device, a trailer tracking device, and an intelligent vehicle device. Such devices may be removably or fixedly mounted in or on a vehicle. In some embodiments, a monitoring service may be provided, for example, by the customer's mobile service provider (e.g., cell phone provider, 3G data service provider, etc.).

According to some embodiments, a telematics device may include a remotely programmable memory (e.g., for designating one or more data items to monitor, record, and/or transmit), and/or various interfaces for wireless and/or hard-wired communications (e.g., for monitoring various aspects of driving and/or for communicating monitored data items).

In some embodiments, accelerometer data may be used for detecting braking, swerving, and/or acceleration, etc. In some embodiments, GPS data may be used for detecting location, speed, and/or time of day, etc.

Although examples interfaces provided in this disclosure may be illustrated as different interfaces, those skilled in the art will readily understand, in light of the present disclosure, that the features and information described with respect to various types of information and/or interfaces, or a subset of such features and information, may be included in a single interface, screen display or application window, or may be presented using multiple such interfaces, displays or windows. For example, a single interface window may be used for inputting relevant claim information and displaying recommended appraisal options on the same screen, tab, or page of an interface.

Some examples of one or more embodiments are described below. The embodiments described in this disclosure are not limited to any such examples. Also, it will be understood that computer readable media (and apparatus comprising such computer readable media) may be configured so as to provide for the functionality described in the examples. Within each broader example, one or more additional, alternative, and/or optional examples of some features may be referenced, and not all such features or examples may be required.

In accordance with some embodiments, historical claim information may comprise information about both 1st and 3rd party claimants, as this may improve understanding of the acceptability and development pattern(s) of customer and non-customer claim experiences. In accordance with some embodiments, historical claim information may comprise information about one or more of: private passenger vehicles (trucks, SUVs, vans, and/or cars), and/or different types of insurance coverage (e.g., physical damage, collision, and comprehensive insurance).

According to some embodiments, certain damage claims may be paid directly (e.g., without requiring an estimate be provided, without requiring that an estimate be reviewed, and/or without requiring a field appraisal), for example, based at least in part on the insured's repair shop of choice (e.g., based on a corresponding score or weight assigned to the repair shop). For example, a high level of comfort with a repair shop may lead to a recommendation to a pay only option (e.g., no estimate required), a moderate level of comfort may lead to a recommendation of an estimate review process, and a low level of comfort may require a field appraisal.

In some embodiments, certain damage claims may be paid directly (e.g., without requiring an estimate be provided, without requiring that an estimate be reviewed, and/or without requiring a field appraisal), for example, if a damage severity score is less than a predetermined threshold (e.g., a relatively low threshold).

Some embodiments are associated with a “coefficient” or a “multiplier”. As used herein, the terms “coefficient” and “multiplier” may be used interchangeably and may refer to any stored or derived value that may be used to modify or multiply a base or initial value. A multiplier may include, in some embodiments, values less than, equal to, and/or greater than 1.00. For example, in some embodiments an appropriate multiplier or coefficient for a desired population may be set at 1.00. Accordingly, applying a multiplier may comprise multiplying by 1.00, or, in some embodiments, not multiplying by the multiplier if the value is exactly 1.00 (e.g., using a first or base value as a second or final value).

Some embodiments are associated with a “factor” and/or “consideration”, such as a particular item of damage claim information. The terms “factor” and “consideration” may be used interchangeably and may refer to a description of such factor (e.g., a type of accident site) and/or to a value of such factor (e.g., a highway type of accident site and/or a corresponding example weight of 250 for that factor).

Numerous embodiments are described in this disclosure, and are presented for illustrative purposes only. The described embodiments are not, and are not intended to be, limiting in any sense.

The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The phrase “based on” does not mean “based only on”, unless expressly specified otherwise. In other words, the phrase “based on” describes both “based only on” and “based at least on”.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “computer-readable memory device”, and/or “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to an environment wherein one or more computing devices may communicate with one another, and/or to any object, entity, component, device, and/or any combination thereof that permits, facilitates, and/or otherwise contributes to or is associated with the transmission of messages, packets, signals, and/or other forms of information between and/or within one or more network devices. Such devices may communicate directly or indirectly, via a wired or wireless medium such as the Internet, LAN, WAN or Ethernet (or IEEE 802.3), Token Ring, or via any appropriate communications means or combination of communications means. In some embodiments, a network may include one or more wired and/or wireless networks operated in accordance with any communication standard or protocol that is or becomes known or practicable. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), the Fast Ethernet LAN transmission standard 802.3-2002® published by the Institute of Electrical and Electronics Engineers (IEEE), or the like. Networks may be or include a plurality of interconnected network devices. In some embodiments, networks may be hard-wired, wireless, virtual, neural, and/or any other configuration of type that is or becomes known. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

What we claim is:

1. An apparatus comprising:
a processor; and
a computer-readable memory in communication with the processor, the computer-readable memory storing instructions that when executed by the processor result in:
determining information relating to a damage claim associated with damaged insured property, the information comprising a plurality of factors;
determining a respective score for each factor of the information relating to the damage claim;
determining a damage severity score for the damage claim based on the respective scores;
determining at least one recommended appraisal option based on the damage severity score; and
transmitting, via a user interface, an indication of the at least one recommended appraisal option.

2. The apparatus of claim 1, wherein the information relating to the damage claim does not include a damage estimate value.

3. The apparatus of claim 1, wherein determining the damage severity score for the damage claim comprises:
generating a total loss factor score.

4. The apparatus of claim 1, wherein determining the damage severity score for the damage claim comprises:
generating an estimate review factor score.

5. The apparatus of claim 1, wherein determining the information relating to the damage claim comprises:
determining at least one of an indication of an accident site, an indication of a primary point of damage, an indication of a speed at impact, and an indication of a collision object type.

6. The apparatus of claim 1, wherein determining the information relating to the damage claim comprises:
determining at least one of an indication of whether the damage claim is associated with a personal injury, an indication of comprehensive loss, an indication of whether a vehicle is non-drivable, an indication of multiple points of damage, an indication of whether one or more airbags were deployed, and an indication of whether glass damage occurred.

7. The apparatus of claim 1, wherein determining the information relating to the damage claim comprises:
determining at least one of an indication of whether a vehicle was towed, and indication of mileage of a vehicle, an indication of whether fire damage occurred, an indication of whether water damage occurred, and an indication of whether a vehicle rolled over in an accident.

8. The apparatus of claim 1, wherein determining a respective score for each factor of the information relating to the damage claim comprises:
determining a respective coefficient corresponding to each factor.

9. The apparatus of claim 1, wherein determining the damage severity score based on the respective scores comprises:
calculating the damage severity score based on the respective scores.

10. The apparatus of claim 1, wherein determining the damage severity score based on the respective scores comprises:
calculating an estimated monetary damage value based on the respective scores in accordance with a generalized linear model formula.

11. The apparatus of claim 1, wherein determining the at least one recommended appraisal option based on the damage severity score comprises:
comparing the damage severity score to at least one predetermined threshold score.

12. The apparatus of claim 1, wherein determining the at least one recommended appraisal option based on the damage severity score comprises:
determining, based on the damage severity score, that a total loss is projected; and
selecting a recommended appraisal option comprising salvage of the damaged insured property.

13. The apparatus of claim 1, wherein determining the at least one recommended appraisal option based on the damage severity score comprises:
determining, based on the damage severity score and without information relating to a field appraisal, that projected damage severity is less than a predetermined damage severity threshold; and
selecting a recommended appraisal option comprising an estimate review process.

14. The apparatus of claim 1, wherein determining the information relating to the damage claim associated with the damaged insured property comprises:
receiving at least a portion of the information relating to the damage claim via a telematics device.

15. An appraisal management system comprising:
a processor;
a user interface controlled by the processor;
a first computer-readable memory in communication with the processor, the first computer-readable memory storing a database of predetermined score data; and
a second computer-readable memory in communication with the processor, the second computer-readable memory storing appraisal option recommendation instructions that when executed by the processor result in:
determining information relating to a damage claim associated with damaged property insured by an insurer, the damage claim being associated with a claimant and the information comprising a plurality of factors;
accessing, from the database of predetermined score data, a respective score for each factor of the information relating to the damage claim;
calculating a damage severity score for the damage claim based on the respective scores;
selecting, based on the damage severity score, a recommended appraisal option for an estimate review process that does not require a field appraisal by an appraisal professional of the insurer;
transmitting, via the user interface, an indication of the recommended appraisal option for the estimate review process;
receiving, via the user interface, an indication that the claimant agrees to provide a damage estimate to the insurer in accordance with the estimate review process; and
storing, in a third computer-readable memory in communication with the processor, an indication that the claimant agrees to provide the damage estimate.

16. The appraisal management system of claim 15, wherein the information relating to the damage claim does not include a damage estimate value.

17. The appraisal management system of claim 15, wherein calculating the damage severity score for the damage claim comprises:
calculating a total loss factor score.

18. The appraisal management system of claim 15, wherein calculating the damage severity score for the damage claim comprises:
calculating an estimate review factor score.

19. The appraisal management system of claim 15, wherein determining the information relating to the damage claim comprises:
determining at least one of an indication of an accident site, an indication of a primary point of damage, an indication of a speed at impact, and an indication of a collision object type.

20. The appraisal management system of claim 15, wherein determining the information relating to the damage claim comprises:
determining at least one of an indication of whether the damage claim is associated with a personal injury, an indication of comprehensive loss, an indication of whether a vehicle is non-drivable, an indication of multiple points of damage, an indication of whether one or more airbags were deployed, and an indication of whether glass damage occurred.

21. The appraisal management system of claim 15, wherein determining the information relating to the damage claim comprises:
determining at least one of an indication of whether a vehicle was towed, and indication of mileage of a vehicle, an indication of whether fire damage occurred, an indication of whether water damage occurred, and an indication of whether a vehicle rolled over in an accident.

22. The appraisal management system of claim 15, wherein accessing a respective score for each factor of the information relating to the damage claim comprises:
accessing a respective coefficient corresponding to each factor.

23. The appraisal management system of claim 15, wherein calculating the damage severity score based on the respective scores comprises:
calculating the damage severity score by summing the respective scores.

24. The appraisal management system of claim 15, wherein calculating the damage severity score based on the respective scores comprises:
calculating an estimated monetary damage value based on the respective scores, in accordance with a generalized linear model formula.

25. The appraisal management system of claim 15, wherein selecting the recommended appraisal option for the estimate review process based on the damage severity score comprises:
comparing the damage severity score to an estimate review threshold score.

26. The appraisal management system of claim 15, wherein selecting the recommended appraisal option for the estimate review process based on the damage severity score comprises:
determining that the damage severity score is less than an estimate review threshold score.

27. The appraisal management system of claim 15, wherein determining the information relating to the damage claim associated with the damaged property comprises:
receiving at least a portion of the information relating to the damage claim via a telematics device.
